(19) United States
(12) Patent Application Publication
(10) Pub. No.: US 2024/0187428 A1
(43) Pub. Date: Jun. 6, 2024

(54) COMMUNICATION SYSTEM, SWITCHING APPARATUS, SWITCHING METHOD, AND PROGRAM

(71) Applicant: NIPPON TELEGRAPH AND TELEPHONE CORPORATION, Tokyo (JP)

(72) Inventors: Masahiro SHIRAISHI, Tokyo (JP); Hiroki NAGAYAMA, Tokyo (JP); Tomoaki WASHIO, Tokyo (JP); Asami MIYAJIMA, Tokyo (JP)

(21) Appl. No.: 18/552,052

(22) PCT Filed: Apr. 1, 2021
(86) PCT No.: PCT/JP2021/014230

§ 371 Date: Sep. 22, 2023

(51) Int. Cl. H04L 9/40

(52) U.S. Cl. CPC H04L 63/1416; H04L 63/1425

(57) ABSTRACT

A communication system that performs communication among a plurality of nodes by a broker-less type publishing/subscribing model, includes: a computer including a memory and a processor configured to detect distribution of unauthorized data from one application that is handled with priority on a subscriber side among one or more applications that are redundant on one or more of the nodes and functioning as a publisher side; and switch an application handled with priority on the subscriber side to another application different from the one application among the one or more applications in a case where distribution of the unauthorized data is detected.

### TECHNICAL FIELD

The present invention relates to a technology for switching a Pub to be handled with priority on a Sub side in response to generation of unauthorized data.

### BACKGROUND ART

In recent years, in order to implement a smart factory, devices on an information network (NW) and devices on a control NW are connected. In the future, a communication model that performs device interconnection and one-to-many, many-to-one communication in a lightweight and flexible manner is expected to be widespread.

A Publish/Subscribe communication (hereinafter, Pub/Sub communication) model has been proposed as a lightweight and flexible communication model as described above. In Pub/Sub communication, there are a Publisher, which is a client on a side on which a message called an event is created and transmitted (distributed), and a Subscriber, which is a client on a side on which the message is received (subscribed).

The Pub/sub communication has three properties of “spatial separation”, “temporal separation”, and “asynchronous processing”. Due to the “spatial separation”, the Publisher and the Subscriber do not need to know existence of each other. The “temporal separation” enables transmission and reception of data even in a case where the Publisher and the Subscriber do not exist on the network at the same time. Furthermore, by the “asynchronous processing”, transmission and reception of an event can be performed asynchronously with other processing of the Publisher or the Subscriber.

The Pub/Sub communication model includes a broker type and a broker-less type. The configuration of the broker type is a configuration in which functions called a broker responsible for properties of the spatial separation, the temporal separation, and the asynchronous processing is arranged between the Pub and the Sub. The configuration of the broker-less type is a distributed configuration in which all nodes (Pub and Sub) include functions responsible for the properties of the spatial separation, the temporal separation, and the asynchronous processing. By providing a function called data distribution service (DDS) in each of the nodes, the above-described broker-less type configuration can be implemented. Note that the Pub/Sub communication model is also referred to as a publishing/subscribing model.

### CITATION LIST

### Non-Patent Literature

Non-Patent Literature 1: What's in the DDS Standard, Internet <URL: https://www.dds-foundation.org/omg-dds-standard/>

### SUMMARY OF INVENTION

### Technical Problem

In a communication system that performs Pub/Sub communication using the DDS, Pubs can be made redundant by a basic function of the DDS, and for example, which Pub among a plurality of the Pubs in the redundant configuration is handled as a prioritized Pub (hereinafter, priority Pub) can be automatically switched.

However, the above switching is performed in a case where a failure or the like occurs in a priority Pub and there is no communication with Subs. Therefore, in the basic function of the DDS, for example, a priority Pub cannot be automatically switched in a case where the priority Pub is taken over by a third party having an unauthorized purpose and data of unauthorized contents (for example, data for the purpose of attacking a Sub, and the like) is transmitted.

The present invention has been made in view of the above points, and an object of the present invention is to provide a technology for switching a Pub handled with priority on a Sub side in response to generation of unauthorized data in a communication system that performs Pub/Sub communication.

### Solution to Problem

According to the disclosed technology, a communication system is provided that performs communication among a plurality of nodes by a broker-less type publishing/subscribing model, the communication system including:
an unauthorized data generation detection unit that detects distribution of unauthorized data from one application that is handled with priority on a subscriber side among one or more applications that are redundant on one or more of the nodes and functioning as a publisher side; and
a switching unit that switches an application handled with priority on the subscriber side to another application different from the one application among the one or more applications in a case where distribution of the unauthorized data is detected.

### Advantageous Effects of Invention

According to the disclosed technology, a technology is provided that enables switching a Pub to be handled with priority on a Sub side in response to generation of unauthorized data in a communication system that performs Pub/Sub communication.

### BRIEF DESCRIPTION OF DRAWINGS

FIG. 1 is a diagram for describing Pub/Sub communication using DDS.

FIG. 2 is a diagram illustrating a system configuration example in which the DDS is incorporated.

FIG. 3 is a diagram illustrating a configuration example of a system including a plurality of nodes.

FIG. 4 is a diagram for describing an outline of an example.

FIG. 5 is a diagram illustrating a system configuration example in the example.

FIG. 6 is a diagram for describing configuration management.

FIG. 7 is a diagram illustrating a configuration example of a detection unit in the example.

FIG. 8 is a diagram illustrating a configuration example of a configuration management unit in the example.

FIG. 9 is a diagram illustrating a configuration example of a coping unit in the example.

FIG. 10 is a diagram illustrating a configuration example of a DDS operation function unit in the example.

FIG. 11 is a diagram illustrating a processing flow in the example.

FIG. 12 is a diagram illustrating a hardware configuration example of devices.

### DESCRIPTION OF EMBODIMENTS

Hereinafter, an embodiment of the present invention (present embodiment) will be described with reference to the drawings. The embodiment described below is only an example, and an embodiment to which the present invention is applied is not limited to the following embodiment.

In the embodiment described below, an example in which the present invention is applied to a communication system that performs Pub/Sub communication using DDS will be described, but the present invention is applicable not only to the Pub/Sub communication using the DDS.

### Pub/Sub Communication Using DDS

First, DDS and Pub/Sub communication using the DDS as premises of the present embodiment will be described.

In the present embodiment, the above-described broker-less type configuration is employed, and the DDS includes a function corresponding to a broker, thereby implementing the broker-less type.

Here, delivery range management in the DDS will be described. In the DDS, a delivery NW is added to an NW I/F of a node. A delivery range set by a user is operated by this delivery NW and a filter inside the DDS, and enables transmission and reception of data appropriate for an application functioning as a Pub or a Sub.

Specifically, in the DDS, based on a data bus and the delivery range set by the user, a multicast address is assigned to the NW I/F that can be used in nodes, and the delivery NW is prepared. Whether to perform distribution by unicast using an existing IP address of a node or by a newly assigned multicast address can also be set when the delivery range is designated, and thus a physical data distribution range can be defined.

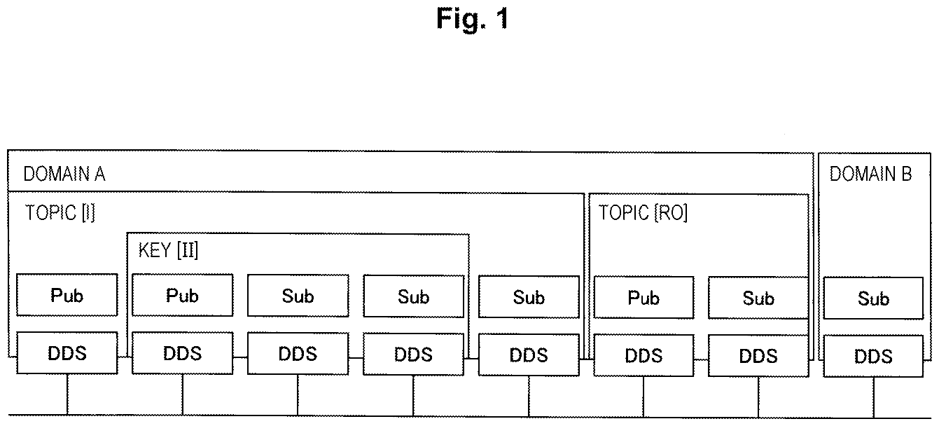

FIG. 1 Illustrates an example of delivery ranges. In the example of FIG. 1, a domain A and a domain B are set as the delivery ranges. Furthermore, in the domain A, a delivery range for a topic [i] and a delivery range for a topic [ro] are set. Furthermore, a delivery range of a key [II] is set within the delivery range of the topic [i].

### System Configuration Example in Which DDS is Incorporated

The DDS is a program that functions as middleware in a node (may be referred to as a computer, a communication device, or the like). A processing program as a base necessary for communication in the DDS is prepared as a library. A DDS program can be generated using this library from a data definition file for communication program generation including, as parameters, definitions (type, size, name, QoS, and the like) of data transmitted by an application (described as “APP”) . Generation of the DDS itself is an existing technology.

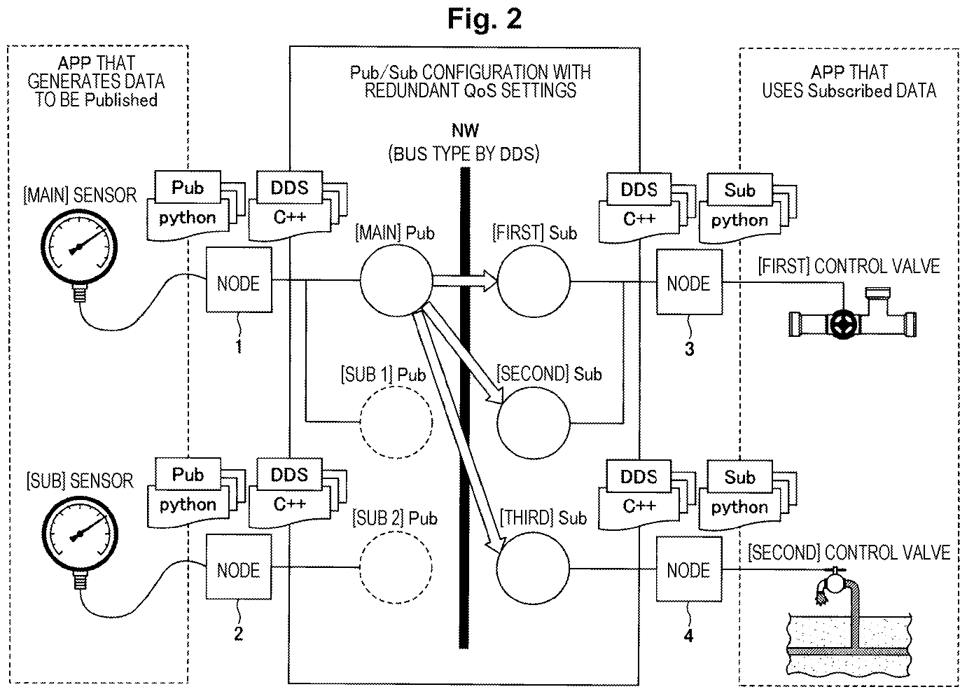

FIG. 2 is a diagram illustrating a system configuration example in which the DDS is incorporated. FIG. 2 physically illustrates a configuration in which a plurality of nodes (computers) to which sensors and control valves are connected is connected to a logical bus network.

A sensor is connected to each of nodes 1 and 2, and an APP that generates data to be published and the DDS are mounted on each of the nodes 1 and 2. A control valve is connected to each of nodes 2 and 3, on which an APP that uses subscribed data and the DDS are mounted.

The example of FIG. 2 illustrates an example in which a Pub/Sub configuration with redundant Qos settings is implemented by the DDS. Specifically, the DDS of the node 1 configures a main Pub and a sub 1 Pub, and the DDS of the node 2 configures a sub 2 Pub. Furthermore, the DDS of the node 3 configures a first Sub and a second Sub, and the DDS of the node 4 configures a third Sub.

Note that, in the example of FIG. 2, an example in which APPs are described in python and the DDS is described in C++ is illustrated, but these are merely examples, and the APPs may be described in any program language. Furthermore, in a case where the Pub/Sub configuration is changed, there are changes that can be done partially and dynamically such as QoS, and changes that require restart of a process (including modification of a program).

Hereinafter, an example will be described as an example of the technology according to the present embodiment.

### System Configuration Example as Base in Present Example

Next, an example of a communication system as a base in the present example will be described. In the communication system as the base in the present example, one node may belong to a plurality of domains. Furthermore, a plurality of Pubs/Subs may exist in one node. Note that, here, the Pub is an application that generates data to be published, and the Sub is an application that uses subscribed data. The functions related to the Pub/Sub communication are performed by the DDS.

Furthermore, both a Pub/Sub may exist in one node, and a Pub/Sub across a plurality of domains may exist in one node. Furthermore, a plurality of Pubs or a plurality of Subs may exist in one APP. Furthermore, the Pubs or the Subs in the same APP can be distinguished from one another. Furthermore, in the communication system in the present example, communication is plain text.

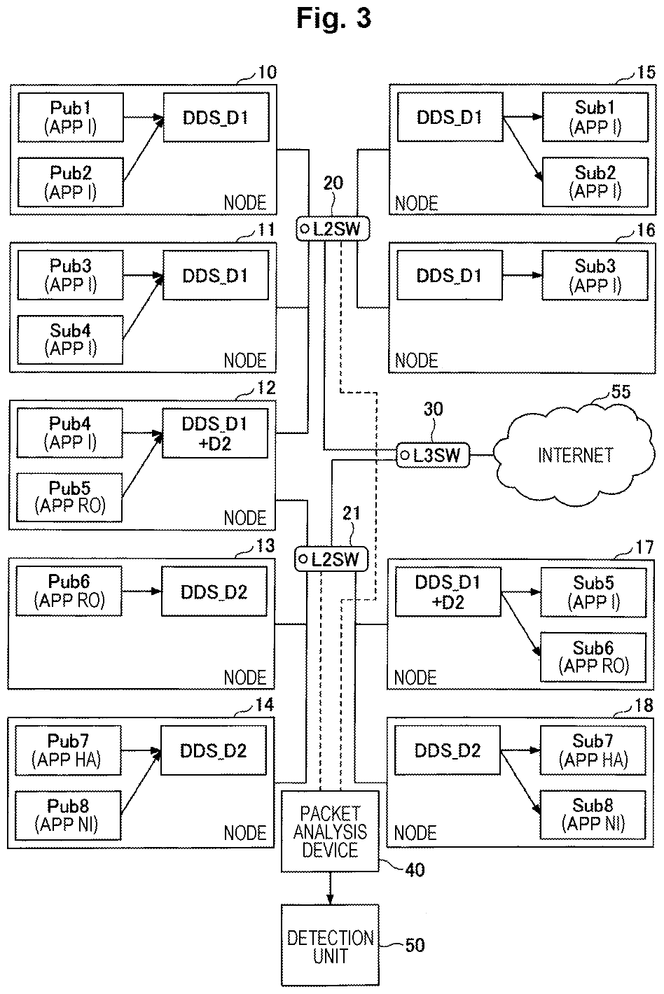

FIG. 3 illustrates a configuration example of the communication system as the base in the present example. As illustrated in FIG. 3, the communication system includes nodes 10 to 18, L2SWs (layer 2 switches) 20 and 21, an L3SW (layer 3 switch) 30, a packet analysis device 40, and a detection unit 50.

In the example of FIG. 3, the nodes 10, 11, 12, 15, 16, and 17 belong to a domain D1, and the nodes 12, 13, 17, and 18 belong to a domain D2. For example, a domain to which a node belongs is indicated as D1 in “DDS_D1” of the node 10. The node 12 and the node 17 belong to both the domain D1 and the domain D2.

For example, in the node 10, a “Pub1 (APP i)” is an application for publishing data of a topic [i], and functions as a Pub1 (Publisher1) in the Pub/Sub communication. In the node 10, there are two Pubs of the Pub1 (APP i) and a Pub2 (APP i). This indicates that there is one APP but the function of the DDS enables the one APP to function as the two Pubs. The same applies to a Sub as indicated in the node 15.

Furthermore, the node 11 includes both a Pub and a Sub of a Pub3 and a Sub4. There is a plurality of APPS that functions as a plurality of Pubs in the nodes 12 and 14, and there is a plurality of APPS that functions as a plurality of Subs in the nodes 17 and 18.

Furthermore, in the communication system illustrated in FIG. 3, the Pub1 (APP i) to a Pub4 (APP i) exist, and Pubs of the “APP i” are made redundant. Similarly, a Pub5 (APP ro) to a Pub6 (APP ro) exist, and Pubs of the “APP ro” are also made redundant.

Furthermore, the Internet 55 is connected to an end of the L3SW 30, and each node can communicate with the Internet 55. Furthermore, the packet analysis device 40 is connected to the L2SWs 20 and 21, and for example, the detection unit 50 can perform anomaly detection based on a packet analysis result.

### Outline of Present Example

For example, a case will be considered in which, for a certain topic, there are three redundant Pubs of a first Pub, a second Pub, and a third Pub, and each of the Subs of the first Sub to the third Sub treats the first Pub as a priority Pub. In this case, data is distributed from each of the first Pub to the third Pub to each of the Subs, but only data distributed from the first Pub is transferred to APPs on a Sub side.

In a basic function of the DDS, in a case where a failure or the like occurs in the first Pub, each of the Subs can switch the priority Pub to the second Pub or the third Pub. However, as described above, in the basic function of the DDS, the priority Pub cannot be switched to the second Pub or the third Pub, for example, in a case where the first Pub is taken over by a third party and transmitting data of unauthorized contents (for example, data for the purpose of attacking a Sub, and the like).

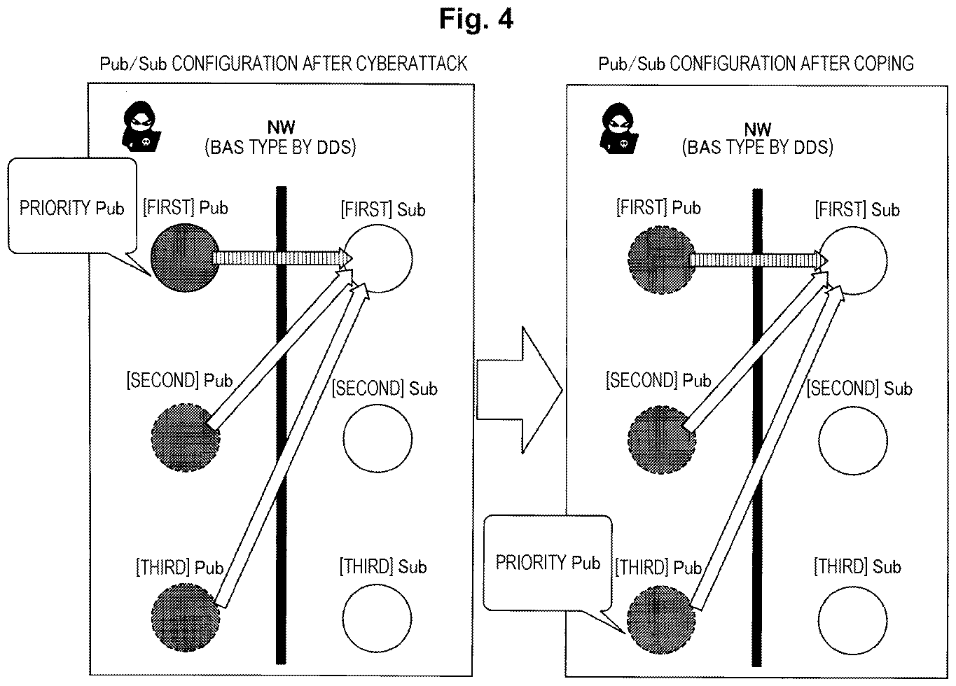

In the present example, a mechanism is provided that enables switching a priority Pub in a case where the priority Pub is transmitting data of authorized contents (hereinafter, unauthorized data). FIG. 4 illustrates an outline of this mechanism. The example of FIG. 4 illustrates a state in which the priority Pub is switched to the third Pub in a case where the first Pub that is the priority Pub is taken over by a cyberattack and transmitting unauthorized data. According to this switching, data distributed from the third Pub is passed to the APP in each of the Subs.

### System Configuration Example in Present Example

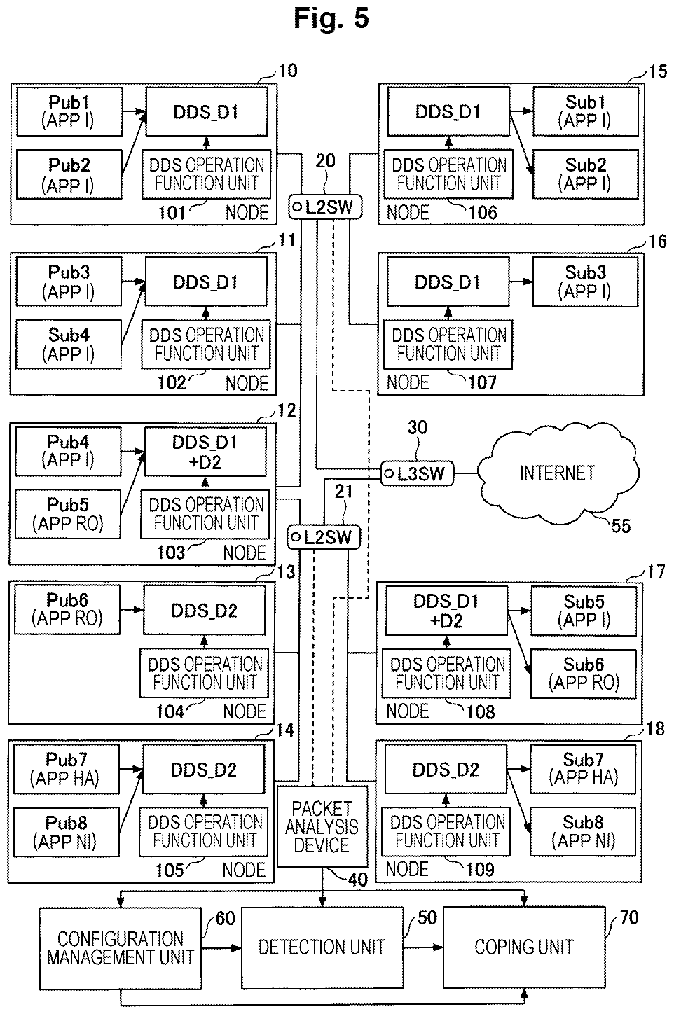

FIG. 5 illustrates a configuration example of a communication system in the present example. As illustrated in FIG. 5, compared to the communication system as the base illustrated in FIG. 3, a DDS operation function unit is provided for each node, and a configuration management unit 60 and a coping unit 70 are included. Each of the DDS operation function units implements a function of switching the priority Pub in response to an instruction from the coping unit 70. FIG. 5 illustrates an example in which the nodes 10 to 18 include the respective DDS operation function units 101 to 109. Hereinafter, in a case where a node is not distinguished, the DDS operation function unit is referred to as a DDS operation function unit 100.

The configuration management unit 60 manages configuration information (NW configuration information) of the communication system, and the coping unit 70 performs processing for switching of a priority Pub in response to detection of unauthorized data by the detection unit 50. At this time, the coping unit 70 uses the configuration information to decide which Pub among the redundant Pubs is to serve as the priority Pub. Note that the detection unit 50, the configuration management unit 60, and the coping unit 70 may be included in the packet analysis device 40 or may be included in a device different from the packet analysis device 40. In the present example, it is assumed that the packet analysis device 40 includes the detection unit 50, the configuration management unit 60, and the coping unit 70.

### Configuration Management

In the configuration management unit 60, the configuration information of the communication system needs to be managed. Although the configuration information may be created and managed by any method, in the present example, the configuration information is created and managed by a plurality of items of relationship information that can be created from communication (traffic) flowing among the nodes being combined.

As the relationship information, three layers of an “IP relationship layer”, a “participant relationship layer”, and a “Pub/Sub relationship layer” representing topology of the horizontal axis of the NW are created. Since the IP relationship layer and the participant relationship layer are associated with each other, and the participant relationship layer and the Pub/Sub relationship layer are associated with each other, all the three layers are eventually associated with each other, and by combining these three layers, a “combined layer” representing topology of the vertical axis of the NW is obtained. Configuration information is managed by holding the combined layer for a plurality of generations. Note that a generation refers to, for example, a division obtained by performing division by a certain time interval, an event interval, or the like. However, holding a plurality of generations is not essential, and for example, only the latest one generation may be held.

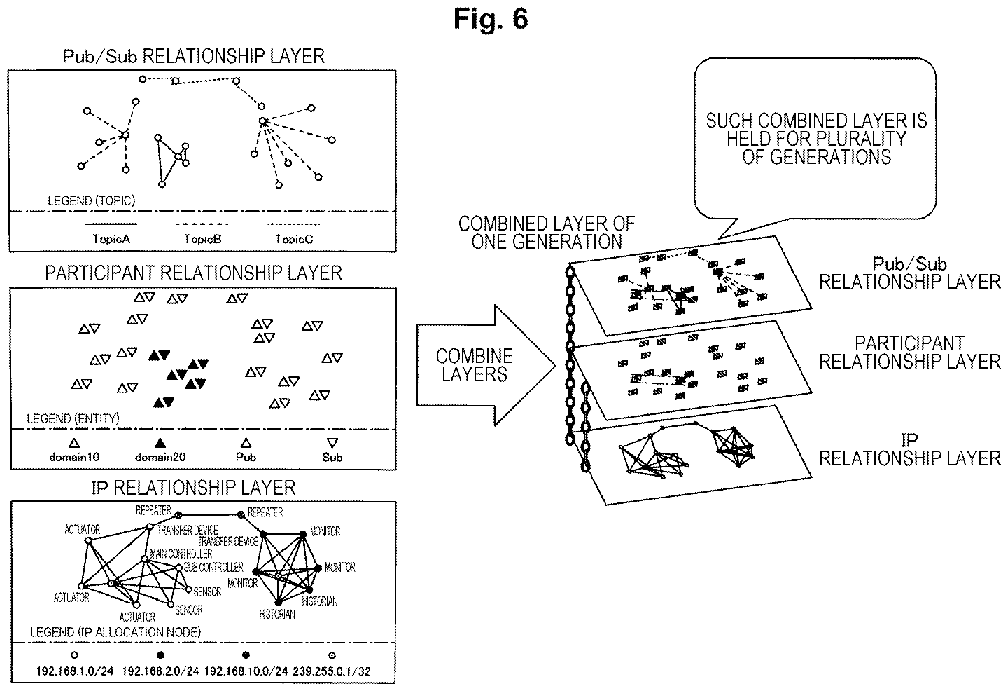

FIG. 6 illustrates an example of the IP relationship layer, the participant relationship layer, the Pub/Sub relationship layer, and the combined layer. As illustrated in FIG. 6, the IP relationship layer is represented by a graph structure in which IP addresses are vertices and transmission and reception relationships of data at an IP level are edges. In the IP relationship layer, in a case where there is an edge between vertices, it indicates that there is a data transmission and reception relationship between nodes including IP addresses represented by the vertices. Note that one node may have a plurality of IP addresses (for example, an IP address for multicast may be included in addition to an IP address for unicast). The participant relationship layer represents a globally unique identifier (GUID) of a node using one symbol (triangular or inverted triangular symbol), and each symbol represents whether the domain to which each GUID belongs is a Pub or a Sub. The Pub/Sub relationship layer includes GUIDs of the nodes as vertices and relationships of whether the nodes belong to the same topics as edges, and represents relationships of topics to which the GUIDs belong. Note that the participant relationship layer is also represented by a graph structure including the above symbols (triangular or inverted triangular symbols) as vertices. In the example of FIG. 6, there is no edge in the graph structure representing the participant relationship layer, but for example, vertices belonging to the same domains may be connected by edges.

The Pub/Sub relationship layer can be created using information acquired from communication as data distribution, and the participant relationship layer can be created using information acquired from communication for DDS operation. Meanwhile, the IP relationship layer can be created using information acquired from both communication as data distribution and communication for DDS operation. Note that the communication for DDS operation is communication performed in a case where a node participates in the Pub/Sub communication; communication performed in a case where another node is searched for; communication performed in a case where distribution contents are agreed; and the like.

In the IP relationship layer, one vertex is associated with a 5-tuple including an IP address of a node (src/dst IP addresses, src/dst port numbers, protocol number). In the participant relationship layer, a GUID and a port number are associated with one symbol (triangular or inverted triangular symbol). In the Pub/Sub relationship layer, a GUID and a topic name are associated with one vertex. The GUID is an identifier used in the DDS, and is generated from an IP address, a port number, and the like. Note that one node may include a plurality of GUIDs (for example, in a case where one node functions as both a Pub and a Sub; in a case where one node belongs to a plurality of domains or a plurality of topics; and the like).

Therefore, the IP relationship layer can be associated with the participant relationship layer using port numbers, and the participant relationship layer can be associated with the Pub/Sub relationship layer using GUIDs. By combining the three layers being combined by these associations, the combined layer is obtained as the NW configuration information of the communication system that performs Pub/Sub communication. This combined layer is held, for example, for a plurality of generations.

Here, in a case of focusing on one node in the combined layer, one or more vertices of the IP relationship layer (5-tuple including IP addresses) correspond to this node, and one or more vertices of the participant relationship layer (port numbers and GUIDs) are associated with the one or more vertices. Furthermore, zero or more vertices of the Pub/Sub relationship layer (GUIDs and topic names) are associated with the one or more vertices of the participant relationship layer. That is, in the combined layer, for each node, a tree structure having the node as a vertex (a tree structure in which the highest hierarchy level represents the IP address, the next hierarchy level represents the port number, the next hierarchy level represent the GUID, and the lowest hierarchy level represents the topic name) is obtained, and the tree structure represents vertical axis topology.

### Configuration Example of Each Unit in Present Example

In the present example, a mechanism is provided that enables switching a priority Pub in a case where the priority Pub is transmitting unauthorized data using the above configuration information.

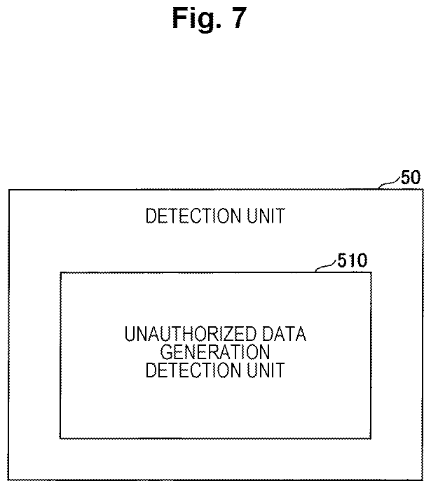

FIG. 7 illustrates a configuration example of the detection unit 50. As illustrated in FIG. 7, the detection unit 50 includes an unauthorized data generation detection unit 510. Operations of the unauthorized data generation detection unit 510 will be described in a sequence to be described below.

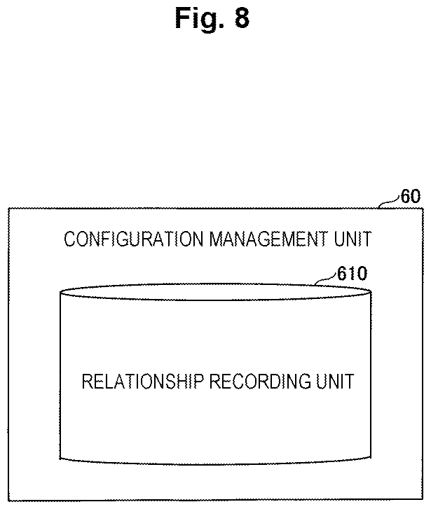

FIG. 8 illustrates a configuration example of the configuration management unit 60. As illustrated in FIG. 8, the configuration management unit 60 includes a relationship recording unit 610 in which configuration information of at least one generation (IP relationship layer, participant relationship layer, Pub/Sub relationship layer, and combined layer) is recorded. Note that it is assumed that the configuration information is created in advance and recorded in the relationship recording unit 610.

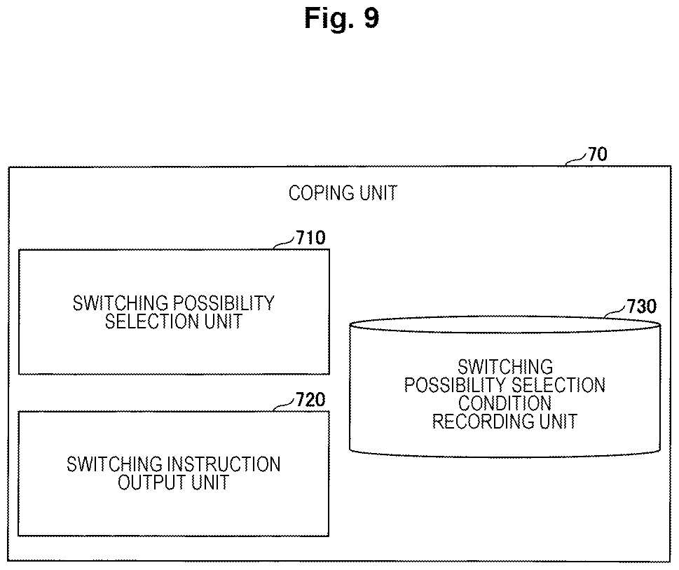

FIG. 9 illustrates a configuration example of the coping unit 70. As illustrated in FIG. 9, the coping unit 70 includes a switching possibility selection unit 710, a switching instruction output unit 720, and a switching possibility selection condition recording unit 730. Operations of these units and the like will be described in a sequence to be described below.

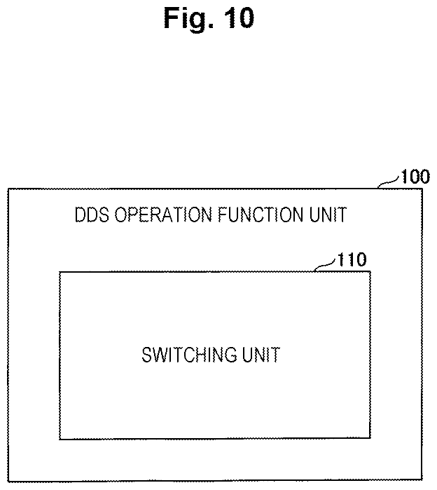

FIG. 10 illustrates a configuration example of the DDS operation function unit 100. As illustrated in FIG. 10, the DDS operation function unit 100 includes a switching unit 110. Operations of the switching unit 110 will be described in the sequence to be described below.

In the present example, the above units detect generation of unauthorized data, and switch a Pub to be handled with priority on a Sub side in response to the detection.

### Sequence Example of Present Example

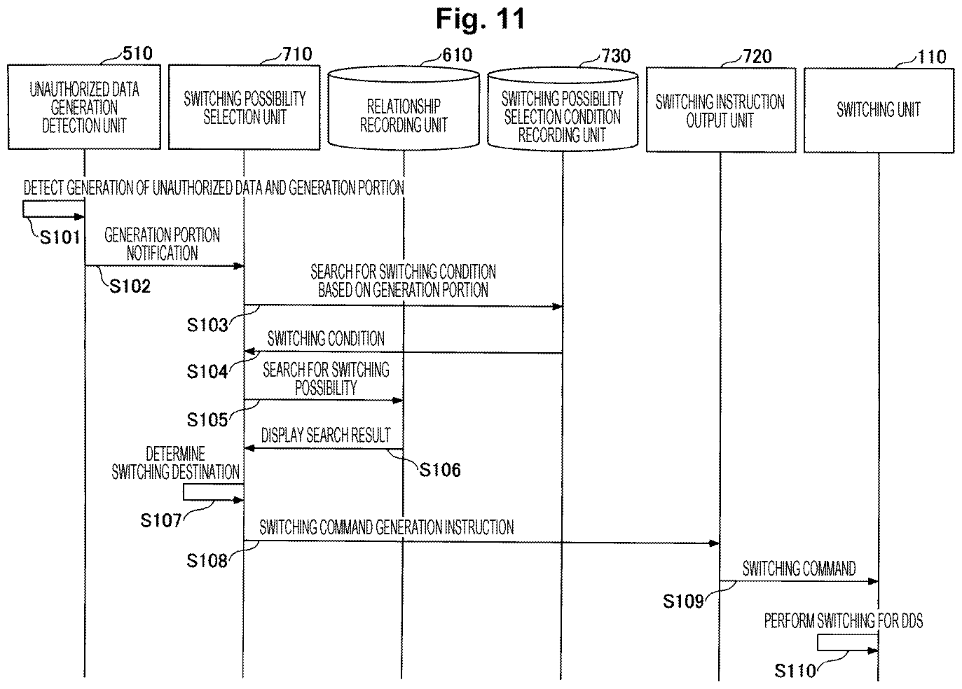

Next, an operation example of the communication system in the present example will be described with reference to a sequence diagram of FIG. 11.

The unauthorized data generation detection unit 510 detects generation of unauthorized data and a location of generation (that is, a Pub that has transmitted the unauthorized data) in the communication system (S101). The unauthorized data is data of unauthorized contents (that is, data of originally unintended contents). Examples of the unauthorized data include data that is transmitted by a Pub taken over by a malicious third party and is for the purpose of attacking a Sub, data of numeral values in a range in which transmission cannot be originally performed by Pub side APPs, data of contents that cannot be normally recognized even if received by Sub side APPs, and the like. Such detection of generation of unauthorized data and the location of generation are performed by an existing technology.

The unauthorized data generation detection unit 510 notifies the switching possibility selection unit 710 of the location of generation of the unauthorized data (that is, a Pub that has transmitted the unauthorized data) (S102). The switching possibility selection unit 710 searches in the switching possibility selection condition recording unit 730 for a switching condition based on the location of generation, and acquires the switching condition as a search result (S103 to S104).

Here, the switching possibility selection condition recording unit 730 records switching conditions for switching a Pub transmitting unauthorized data to another Pub in the redundant configuration. Such switching conditions may be recorded, for example, for each Pub, may be recorded for each domain or topic, or may be recorded for each item of other information (for example, GUIDs and the like).

Various switching conditions are conceivable, and for example, the following conditions are conceivable.
The Pub is switched to a Pub designated in advance as a switching target among other Pubs in the redundant configuration. Note that in a case where this switching condition is used, processing of S105 to S107 to be described below do not need to be performed.
The Pub is switched to a Pub on a node different from that of the Pub transmitting unauthorized data among other Pubs in the redundant configuration.
The Pub is switched to a Pub on a node different from that of the Pub transmitting unauthorized data and having the smallest amount of distribution data among other Pubs in the redundant configuration.

However, the above switching conditions are merely examples, and various conditions can be adopted as long as being conditions for switching to another Pub in the redundant configuration.

Next, the switching possibility selection unit 710 searches for a Pub as a switching candidate using configuration information recorded in the relationship recording unit 610 and displays a search result (S105 to S106). Here, a Pub as a switching candidate can be obtained by searching for a Pub satisfying the switching condition among Pubs that distribute data of the same topic as the Pub transmitting the unauthorized data (that is, other Pubs that are made redundant). Here, it is assumed that one or more Pubs satisfying such a switching condition have been searched for.

Next, the switching possibility selection unit 710 decides a Pub as a switching destination from the one or more Pubs searched for in the above (S107). This may be decided randomly from the one or more Pubs searched for in the above, or may be decided using some criteria (for example, order decided in advance in the Pubs in the redundant configuration, and the like).

Subsequently, the switching possibility selection unit 710 transmits a command generation instruction for setting the switching destination Pub decided in the above as the priority Pub to the switching instruction output unit 720 (S108). Upon receiving the command generation instruction, the switching instruction output unit 720 generates a command for setting the switching destination Pub decided in the above S107 as the priority Pub (hereinafter, switching command), and transmits the command to the switching units 110 (S109). Note that the switching possibility selection unit 710 transmits the switching command to both the switching units 110 of the switching destination Pub and a Sub that receives data from the switching destination Pub. However, the contents of the switching command may be different between the switching destination Pub and the Sub that receives data from the switching destination Pub.

Upon receiving the switching command, the switching units 110 perform the switching command for DDS (S110). Note that, at this time, restart of the process and the like are also performed as necessary. As a result, the priority Pub is switched from the Pub transmitting the unauthorized data to the switching destination Pub.

Here, several specific methods for setting the above switching destination Pub as a priority Pub can be considered, and for example, any one of the following methods (1) to (3) can be considered.
(1) The value of OWNERSHIP_STRENGTH of the switching destination Pub is set to a value higher than the current priority Pub.
(2) A switching candidate Pub and all Subs receiving data transmitted from the current priority Pub are instructed to stop the current process, and perform a program in which the setting of Ownership is changed from Exclusive to Shared.
(3) A switching candidate Pub and all the Subs receiving data transmitted from the current priority Pub are instructed to stop distribution and reception of a topic name used when generation of unauthorized data is detected, change the topic name to the topic name of the switching candidate, and perform a program. At this time, key information may be further set in order to make the switching candidate recognized as the only distribution destination.

Note that detection of generation of unauthorized data can be quickly coped with by the above method (1), but in a case where the value of OWNERSHIP_STRENGTH of a Pub transmitting the unauthorized data is set to a higher value, Subs may receive the unauthorized data again. On the other hand, while the above methods (2) and (3) are inferior to the above method (1) in quickness, there is no risk that Subs receive unauthorized data again after coping. Therefore, which of the above methods (1) to (3) is adopted may be appropriately decided in consideration of the quickness of coping and the like. Alternatively, for example, measures may be taken by the method (2) or (3) after measures are provisionally taken by the method (1).

### Hardware Configuration Example

A node including a DDS operation function unit 100 and the packet analysis device 40 including the detection unit 50, the configuration management unit 60, and the coping unit 70 in the present embodiment can be implemented, for example, by causing a computer to perform a program in which the processing contents described in the present embodiment are described.

The above program may be recorded in a computer-readable recording medium (such as a portable memory) to be stored and distributed. Also, the program may be provided through a network such as the Internet or an electronic mail.

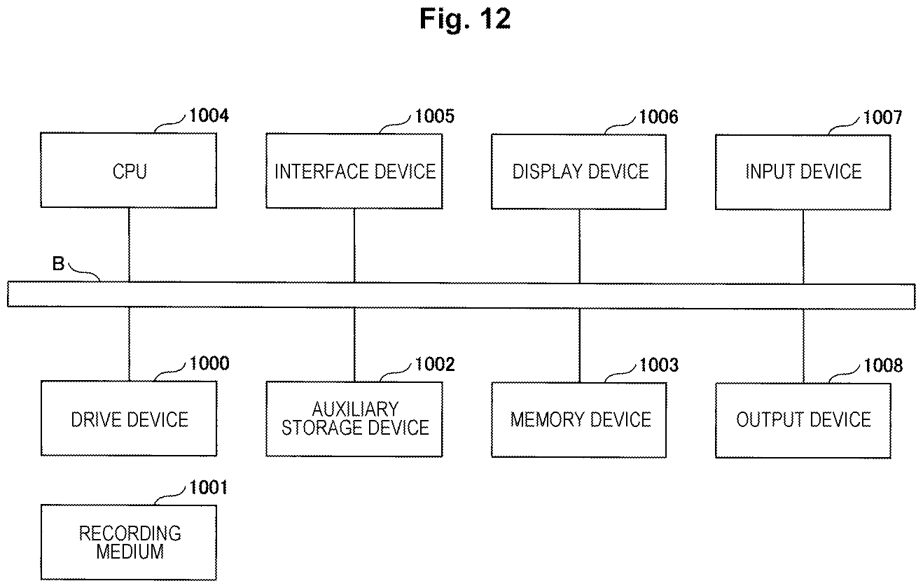

FIG. 12 is a diagram illustrating a hardware configuration example of the above computer. The computer of FIG. 12 includes a drive device 1000, an auxiliary storage device 1002, a memory device 1003, a CPU 1004, an interface device 1005, a display device 1006, an input device 1007, an output device 1008, and the like, which are connected to each other by a bus B.

The program for performing processes in the computer is provided through a recording medium 1001 such as a CD-ROM or a memory card, for example. When the recording medium 1001 that stores the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is issued, the memory device 1003 reads the program from the auxiliary storage device 1002, and stores the program therein. The CPU 1004 implements functions related to the configuration management unit 60 according to the program stored in the memory device 1003. The interface device 1005 is used as an interface for connection to the network. The display device 1006 displays a graphical user interface (GUI) or the like according to the program. The input device 1007 includes a keyboard and a mouse, buttons, a touch panel, or the like, and is used to input various operation instructions. The output device 1008 outputs a calculation result. Note that the node or the packet analysis device 40 may not include either or both of the display device 1006 and the input device 1007.

### Effect of Embodiment

According to the technology of the present embodiment, a Pub to be handled with priority on a Sub side can be switched in response to generation of unauthorized data.

### Summary of Embodiment

The present description discloses at least a communication system, a switching apparatus, a switching method, and a program described in the following clauses.

### Clause 1

A communication system that performs communication among a plurality of nodes by a broker-less type publishing/subscribing model, the communication system including:
an unauthorized data generation detection unit that detects distribution of unauthorized data from one application that is handled with priority on a subscriber side among one or more applications that are redundant on one or more of the nodes and functioning as a publisher side; and
a switching unit that switches an application handled with priority on the subscriber side to another application different from the one application among the one or more applications in a case where distribution of the unauthorized data is detected.

### Clause 2

The communication system according to the clause 1 further including
a decision unit that decides the another application handled with priority on the subscriber side based on a predetermined switching condition and configuration information indicating a network configuration of the communication system,
in which the switching unit switches an application handled with priority on the subscriber side to the another application decided by the decision unit in a case where distribution of the unauthorized data is detected.

### Clause 3

The communication system according to the clause 2,
in which the switching condition is a condition indicating that an application on a node different from a node of the one application among the one or more applications is set as an application handled with priority on the subscriber side, or a condition indicating that an application on a node different from a node of the one application and having the smallest amount of distribution data among the one or more applications is set as an application handled with priority on the subscriber side.

### Clause 4

A switching apparatus connected to a plurality of nodes that perform communication by a broker-less type publishing/subscribing model, the switching apparatus including:
an unauthorized data generation detection unit that detects distribution of unauthorized data from one application that is handled with priority on a subscriber side among one or more applications that are redundant on one or more of the nodes and functioning as a publisher side; and
a switching instruction unit that transmits an instruction to switch an application handled with priority on the subscriber side to another application different from the one application among the one or more applications in a case where distribution of the unauthorized data is detected.

### Clause 5

The switching apparatus according to the clause 4 further including
a decision unit that decides the another application handled with priority on the subscriber side based on a predetermined switching condition and configuration information indicating a network configuration of a communication system including the plurality of nodes,
in which the switching instruction unit transmits an instruction to switch an application handled with priority on the subscriber side to the another application decided by the decision unit in a case where distribution of the unauthorized data is detected.

### Clause 6

The switching apparatus according to the clause 5,
in which the switching condition is a condition indicating that an application on a node different from a node of the one application among the one or more applications is set as an application handled with priority on the subscriber side, or a condition indicating that an application on a node different from a node of the one application and having the smallest amount of distribution data among the one or more applications is set as an application handled with priority on the subscriber side.

### Clause 7

A switching method performed by a switching apparatus connected to a plurality of nodes that perform communication by a broker-less type publishing/subscribing model, the switching method including:
an unauthorized data generation detection step for detecting distribution of unauthorized data from one application that is handled with priority on a subscriber side among one or more applications that are redundant on one or more of the nodes and functioning as a publisher side; and
a switching instruction step for transmitting an instruction to switch an application handled with priority on the subscriber side to another application different from the one application among the one or more applications in a case where distribution of the unauthorized data is detected.

### Clause 8

A program causing a computer to function as the switching apparatus according to any one of clauses 4 to 6.

Although the present embodiment has been described above, the present invention is not limited to such a specific embodiment, and various modifications and changes can be made within the scope of the present invention disclosed in the claims.

### REFERENCE SIGNS LIST

10 to 18 Node
20, 21 L2SW
30 L3SW
40 Packet analysis device
50 Detection unit
55 Internet
60 Configuration management unit
70 Coping unit
100 DDS operation function unit
110 Switching unit
510 Unauthorized data generation detection unit
610 Relationship recording unit
710 Switching possibility selection unit
720 Switching instruction output unit
730 Switching possibility selection condition recording unit
1000 Drive device
1001 Recording medium
1002 Auxiliary storage device
1003 Memory device
1004 CPU
1005 Interface device
1006 Display device
1007 Input device
1008 Output device

1. A communication system that performs communication among a plurality of nodes by a broker-less type publishing/subscribing model, the communication system comprising:
a computer including a memory and a processor configured to
detect distribution of unauthorized data from one application that is handled with priority on a subscriber side among one or more applications that are redundant on one or more of the nodes and functioning as a publisher side; and
switch an application handled with priority on the subscriber side to another application different from the one application among the one or more applications in a case where distribution of the unauthorized data is detected.

2. The communication system according to claim 1, wherein the processor is further configured to:
decide the another application handled with priority on the subscriber side based on a predetermined switching condition and configuration information indicating a network configuration of the communication system,
wherein the processor switches an application handled with priority on the subscriber side to the another application decided by the processor in a case where distribution of the unauthorized data is detected.

3. The communication system according to claim 2, wherein the switching condition is a condition indicating that an application on a node different from a node of the one application among the one or more applications is set as an application handled with priority on the subscriber side, or a condition indicating that an application on a node different from a node of the one application and having the smallest amount of distribution data among the one or more applications is set as an application handled with priority on the subscriber side.

4. A switching apparatus connected to a plurality of nodes that perform communication by a broker-less type publishing/subscribing model, the switching apparatus comprising:
a memory; and
a processor configured to
detect distribution of unauthorized data from one application that is handled with priority on a subscriber side among one or more applications that are redundant on one or more of the nodes and functioning as a publisher side; and
transmit an instruction to switch an application handled with priority on the subscriber side to another application different from the one application among the one or more applications in a case where distribution of the unauthorized data is detected.

5. The switching apparatus according to claim 4, wherein the processor is further configured to:
decide the another application handled with priority on the subscriber side based on a predetermined switching condition and configuration information indicating a network configuration of a communication system including the plurality of nodes.
wherein the processor transmits an instruction to switch an application handled with priority on the subscriber side to the another application decided by the processor in a case where distribution of the unauthorized data is detected.

6. The switching apparatus according to claim 5, wherein the switching condition is a condition indicating that an application on a node different from a node of the one application among the one or more applications is set as an application handled with priority on the subscriber side. or a condition indicating that an application on a node different from a node of the one application and having the smallest amount of distribution data among the one or more applications is set as an application handled with priority on the subscriber side.

7. A switching method performed by a switching apparatus that includes a memory and a processor, and is connected to a plurality of nodes that perform communication by a broker-less type publishing/subscribing model, the switching method comprising:
detecting distribution of unauthorized data from one application that is handled with priority on a subscriber side among one or more applications that are redundant on one or more of the nodes and functioning as a publisher side; and
transmitting an instruction to switch an application handled with priority on the subscriber side to another application different from the one application among the one or more applications in a case where distribution of the unauthorized data is detected.

8. A non-transitory computer-readable recording medium having computer-readable instructions stored thereon, which, when executed, cause a computer including a memory and processor to function as the switching apparatus according to claim 4.
